(19) United States
(12) Patent Application Publication
(10) Pub. No.: US 2010/0207915 A1
(43) Pub. Date: Aug. 19, 2010

(54) PLASMA DISPLAY APPARATUS

(76) Inventors: Chan Woo Kim, Gumi-si (KR); Seok Dong Kang, Gumi-si (KR)

Correspondence Address: BIRCH STEWART KOLASCH & BIRCH, PO BOX 747, FALLS CHURCH, VA, 22040-0747, US

(21) Appl. No.: 12/682,188

(22) PCT Filed: Feb. 12, 2009
(86) PCT No.: PCT/KR09/00682

§ 371 Date: Apr. 8, 2010

(30) Foreign Application Priority Data
May 29, 2008 (KR) 10-2008-0050424

(51) Int. Cl. G09G 3/28; G06F 3/038

(52) U.S. Cl. 345/205; 345/60

(57) ABSTRACT

The present invention relates to a plasma display apparatus. The plasma display apparatus comprising a plasma display panel having a display area for displaying images and a non-display area disposed at an outer side of the display area, comprises a first electrode, a second electrode, and a third electrode. The first electrode is formed on the display area and the non-display area of an upper substrate. The second electrode forms a pair with the first electrode and is formed in the display area. The third electrode is electrically insulated from the second electrode and formed in the non-display area.

### TECHNICAL FIELD

The present invention relates to a plasma display apparatus. Particularly, the present invention relates to an electrode structure of a panel in a plasma display apparatus.

### BACKGROUND ART

In general, a plasma display panel comprises unit cells that are formed by barriers disposed between an upper substrate and a lower substrate. Each of the unit cells is charged with a main discharge gas such as a neon gas (Ne), a helium gas (He), or a gas mixture thereof (Ne+He), and an inert gas containing a small amount of an xenon gas. When the gas is discharged from the unit cell by a high frequency voltage, the inert gas generates vacuum ultraviolet rays. The plasma display panel displays images by emitting phosphor formed between barriers using the generated vacuum ultraviolet rays. The plasma display panel has been receiving an attention as the next generation display device because it is possible to manufacture a thin and light-weighted plasma display panel.

In case of a typical plasma display panel, a scan electrode and a sustain electrode are formed on an upper substrate. The scan electrode and the sustain electrode have a stacking structure of a transparent electrode and a bus electrode made of indium tin oxide (ITO) in order to secure an aperture ratio of a panel.

Lately, there are many efforts made to develop a plasma display panel having sufficient luminance and driving characteristics with a manufacturing cost reduced.

### DISCLOSURE OF INVENTION

### Technical Problem

Accordingly, an aspect of the present invention is to solve at least the problems and disadvantages of the background art. In accordance with an aspect of the present invention, a plasma display apparatus comprising a plasma display panel having a display area for displaying images and a non-display area disposed at an outer side of the display area, comprises a first electrode, a second electrode, and a third electrode. The first electrode is formed on the display area and the non-display area of an upper substrate. The second electrode forms a pair with the first electrode and is formed in the display area. The third electrode is electrically insulated from the second electrode and formed in the non-display area.

### Solution to Problem

In accordance with another aspect of the present invention, a plasma display apparatus comprising a plasma display panel having a display area for displaying images and an non-display area disposed at outer side of the display area, comprises a first electrode, a second electrode, a third electrode. The first electrode is formed in the display area and the non-display area of an upper substrate. The second electrode forms a pair with the first electrode and is formed in the display area. The third electrode is electrically insulated from the second electrode and formed integrally with the first electrode in the non-display area.

In accordance with another aspect of the present invention, a plasma display apparatus comprising a plasma display panel having a display area for displaying images and an non-display area disposed at outer side of the display area, comprises a first electrode, a second electrode, a black layer, and a third electrode. The first electrode is formed in the display area and the non-display area of an upper substrate. The second electrode forms a pair with the first electrode and is formed in the display area. The black layer is formed at the display area, and the third electrode is separated from the black layer and formed in the non-display area.

### BRIEF DESCRIPTION OF DRAWINGS

FIG. 1 is a perspective view illustrating a plasma display panel in accordance with an embodiment of the present invention;

FIG. 2 is a diagram illustrating arrangement of electrodes in a plasma display panel in accordance with an embodiment of the present invention;

FIG. 3 is a timing diagram illustrating a method for driving a plasma display panel based on a time division scheme by dividing one frame into a plurality of subfields;

FIG. 4 is a timing diagram illustrating a waveform of a driving signal for driving a plasma display panel in accordance with an embodiment of the present invention;

FIG. 5 is a diagram illustrating a driving device for driving a plasma display panel.

FIG. 6 is a diagram illustrating a display area and a non-display area of a plasma display panel.

FIG. 7 to FIG. 9 are cross-sectional views illustrating an electrode structure formed on an upper substrate of a display area of a plasma display panel.

FIG. 10 is a diagram illustrating an electrode structure formed on an upper substrate of a display area and a non-display area of a plasma display panel.

FIGS. 11 to 20 are cross-sectional views illustrating an electrode structure formed on an upper substrate of a plasma display panel in accordance with an embodiment of the present invention;

FIG. 21 is a cross-sectional view illustrating a black matrix formed on an non-display area of a plasma display panel in accordance with a first embodiment of the present invention;

FIG. 22 is a cross-sectional view illustrating an electrode structure formed on an upper substrate of a plasma display panel in accordance with an embodiment of the present invention.

FIGS. 23 and 24 are cross-sectional views illustrating a black matrix formed on an non-display area of a plasma display panel; and

FIG. 25 is a cross-sectional view illustrating a black layer and an electrode structure formed on an upper substrate of a plasma display panel in accordance with an embodiment of the present invention.

### BEST MODE FOR CARRYING OUT THE INVENTION

Preferred embodiments of the present invention will be described in a more detailed manner with reference to the drawings.

It is an object of the present invention to provide a plasma display panel that can be manufactured through a simple manufacturing process with a less manufacturing cost, can enable a plasma display device to have a better exterior appearance, and can be conveniently used, and a plasma display apparatus having the same.

Hereinafter, a plasma display apparatus according to an exemplarily embodiment of the present invention will be described in detail with reference to the drawings.

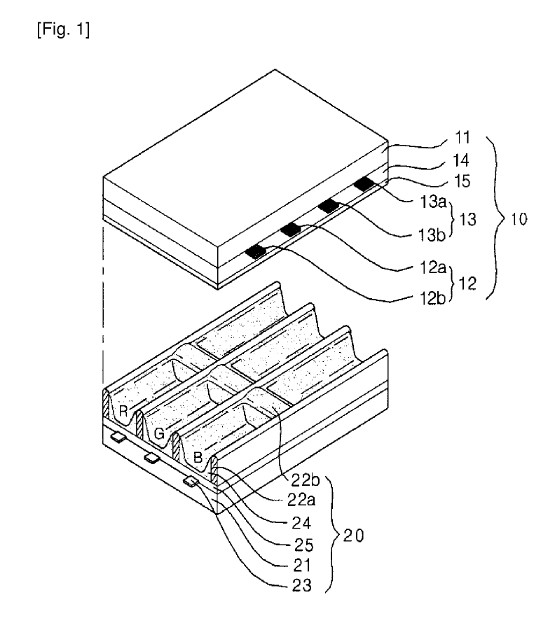

FIG. 1 is a perspective view illustrating a structure of a plasma display panel in accordance with an embodiment of the present invention.

Referring to FIG. 1, the plasma display panel according to the present embodiment comprises an upper panel 10 and a lower panel 20 sealed with the upper panel 10 at a predetermined gap.

The upper panel 10 comprises a pair of sustain electrodes 12 and 13 above the upper substrate 11. The pair of sustain electrodes 12 and 13 is divided into a scan electrode 12 and a sustain electrode 13 by a function. The sustain electrodes 12 and 13 are covered by an upper dielectric layer 14 that limits a discharge current and insulates one electrode pair from the other. A passivation layer 15 is formed above the upper dielectric layer 14. The passivation layer 15 protects the upper dielectric layer 15 from sputtering of charged particles that are generated when the gas is discharged. The passivation layer 15 also improves the discharging efficiency of secondary electrons.

The discharge gas is injected into a discharge space that is prepared between the upper substrate 11 and the lower substrate 21. It is preferable that the discharge gas includes an xenon gas (Xe) more than 10% of the entire discharge gas. If the discharge gas includes the xenon gas more than 10%, the discharge/emission efficiency and luminance of the plasma display panel.

The lower panel 20 comprises barriers for sectoring a plurality of discharge spaces, that is, discharge cells, on the lower substrate 21. Also, the address electrodes 23 are arranged in a direction that crosses the sustain electrode pairs 12 and 13. Phosphor 24 is coated on the lower dielectric layer 25 and the barriers. The phosphor 24 radiates visible rays by ultraviolet rays generated when the gas is discharged.

Each of the barriers 22 comprises a vertical barrier 22a formed in parallel with the address electrode 23 and a horizontal barrier 22b formed in a direction crossing the address electrode 23. The bathers 22 physically divide the discharge cells and prevent the ultraviolet rays and the visible rays from leaking to adjacent cells.

In the plasma display panel, the sustain electrode pairs 12 and 13 are made of opaque metal electrodes only. That is, the sustain electrode pairs 12 and 13 are formed using materials of a typical bus electrode such as silver Ag, copper Cu, or chrome Cr without using transparent electrode material ITO. That is, each of the sustain electrode pairs 12 and 13 of the plasma display panel according to the present embodiment is made of one layer of a bus electrode without a typical ITO electrode.

For example, it is preferable to form the sustain electrode pairs 12 and 13 using silver. It is preferable that the silver Ag has phosphorous characteristic. Each of the sustain electrode pairs 12 and 13 according to the present embodiment may have a color darker and transparency lower than those of the upper dielectric layer 14 or the lower dielectric layer 14 formed on the upper substrate 11.

Each of the red, green, and blue discharge cells may have a symmetric structure in which phosphor layers 24 of the red, green, and blue discharge cells have the same pitch. Or, the each of the red, green, and blue discharge cells may have an asymmetry structure in which the pitches thereof are different from each others. In case of the asymmetric structure, the pitch of the red cell is smaller than that of the green cell, and the pitch of the green cell is smaller than that of the blue cell.

As shown in FIG. 1, the sustain electrodes 12 and 13 may be formed as a plurality of electrode lines in one discharge cell. That is, the first sustain electrode 12 is formed as two electrode lines 12a and 12b, and the second sustain electrode 13 is formed as two electrode lines 13a and 13b symmetrically from the first sustain electrode 12 based on the center of the discharge cell.

It is preferable that the first sustain electrode 12 and the second sustain electrode 13 are a scan electrode and a sustain electrode in consideration of an aperture rate and discharging diffusion efficiency. That is, an electrode line having a narrow width is used in consideration of an aperture rate, and a plurality of electrode lines are used in consideration of the discharging diffusion efficiency. Here, the number of electrode lines may be decided in consideration of not only the aperture rate but also the discharge diffusion efficiency.

Since the structure of the plasma panel structure of FIG. 1 is only the exemplary embodiment of the present invention, the present invention is not limited thereto. For example, a black matrix (BM) may be formed on the upper substrate 11. The black matrix improves a light blocking function for reducing the reflection by absorbing light from the outside. The black matrix also improves the purity and contrast of the upper substrate 11. The black matrix may have a BM structure or an integral BM structure.

The barrier structure of the panel shown in FIG. 1 is a close type in which the discharge cells are closed by the vertical bathers 22a and the horizontal barriers 22b. However, the barrier structure may be a strip type in which a panel comprises only the vertical barriers, or a fish bone structure in which protrusions are formed on the vertical bather at a predetermined gap.

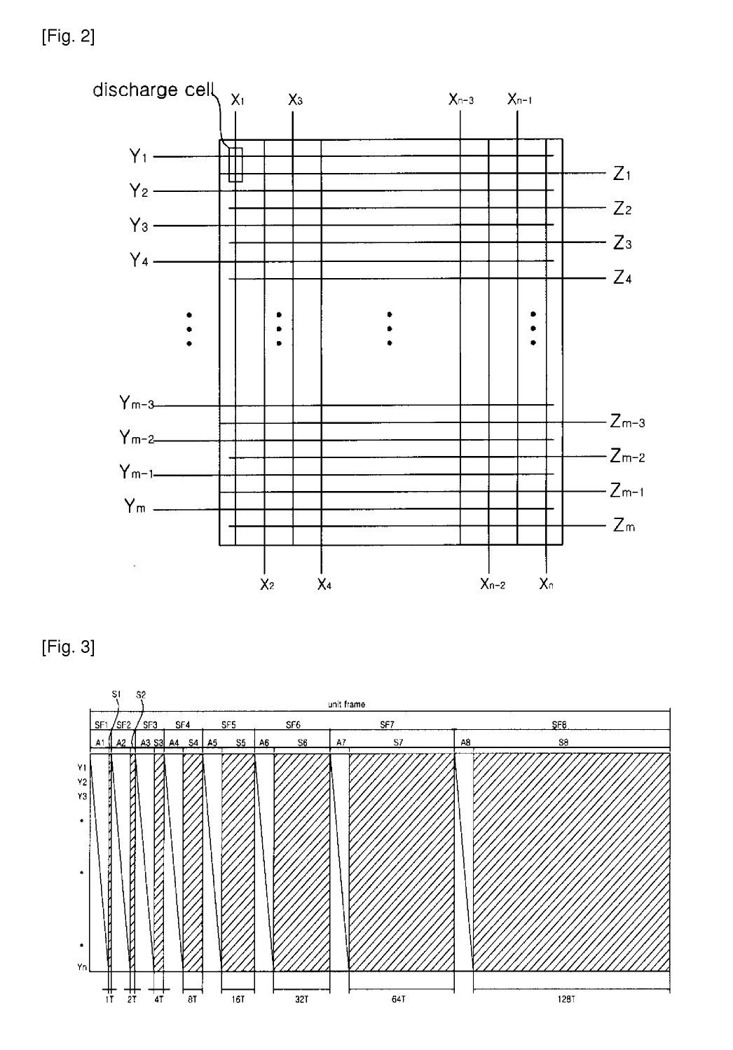

FIG. 2 is a diagram illustrating arrangement of electrodes in a plasma display panel in accordance with an embodiment of the present invention. As shown in FIG. 2, a plurality of discharge cells forming a plasma display panel are preferably disposed in a matrix. Each of the discharge cells is disposed at crossing of sustain electrode lines Y1 to Ym, sustain electrode lines Z1 to Zm, and address electrode lines X1 to Xn. The scan electrode lines Y1 to Ym may be driven sequentially or simultaneously. The sustain electrode lines Z1 to Zm may be simultaneously driven. The address electrode lines X1 to Xn may be driven after dividing the address electrode lines into odd number lines and even number lines or may be driven sequentially.

Since the electrode arrangement shown in FIG. 2 is only an embodiment of the present invention, the present invention is not limited to the electrode arrangement or the driving method shown in FIG. 2. For example, a dual scan method may be applied for simultaneously scanning two of the scan electrode lines Y1 to Ym. Or, the address electrode lines X1 to Xn may be driven after dividing the address electrode lines into upper and lower address electrode lines or left and right address electrode lines based on the center of the panel.

FIG. 3 is a timing diagram illustrating a time division method by dividing one frame into a plurality of subfields. A unit frame may be divided into a predetermined number of subfields such as eight sub fields SF1 to SF8 in order to realize a time division gray display. Also, each of the subfields SF1 to SF8 may be divided into a reset period (not shown), an address period A1 to A8, and a sustain period S1 to S8.

The reset period may be omitted in at least one of the plurality of subfields. For example, the reset period may be included in the first subfield only, or the reset period is included in the first subfield and a predetermined middle subfield.

In each of the address periods A1 to A8, a display data signal is applied to the address electrode X, and a scan pulse corresponding to each scan electrode Y is sequentially applied.

In each of the sustain period S1 to S8, a sustain pulse is alternatively applied to the scan electrode Y and the sustain electrode Z. Accordingly, sustain discharge is generated at discharge cells where wall charge is formed in the address periods A1 to A8.

The luminance of the plasma display panel is in proportion to the number of sustain discharge pulses in the sustain discharge periods S1 to S8 of the unit frame. If one frame for forming one image is expressed with 8-subfields and 256-gray scales, each of the subfields is applied with a different sustain pulse number in an order of 1, 2, 4, 8, 16, 32, 64, and 128. In order to obtain the luminance of 133 gray scales, cells are addressed and sustain discharge is generated in the first subfield period, the third subfield period, and the eighth subfield period.

The number of sustain discharges allocated to each of the subfields may be variably decided according to weights of subfields by an automatic power control (APC) step. Although one frame is divided into eight subfields in FIG. 3, the present invention is not limited thereto. The number of subfields forming one frame can be changed according to the design specification. For example, a plasma display apparatus can be driven by dividing one frame into 12 or 16 subfields or more than 8 subfields.

It is possible to change the number of sustain discharges allocated to each subfield in consideration of gamma characteristics and panel characteristics. For example, a gray scale of the fourth subfield may be lowered from 8 to 6, and a gray scale of the sixth subfield may increase from 32 to 34.

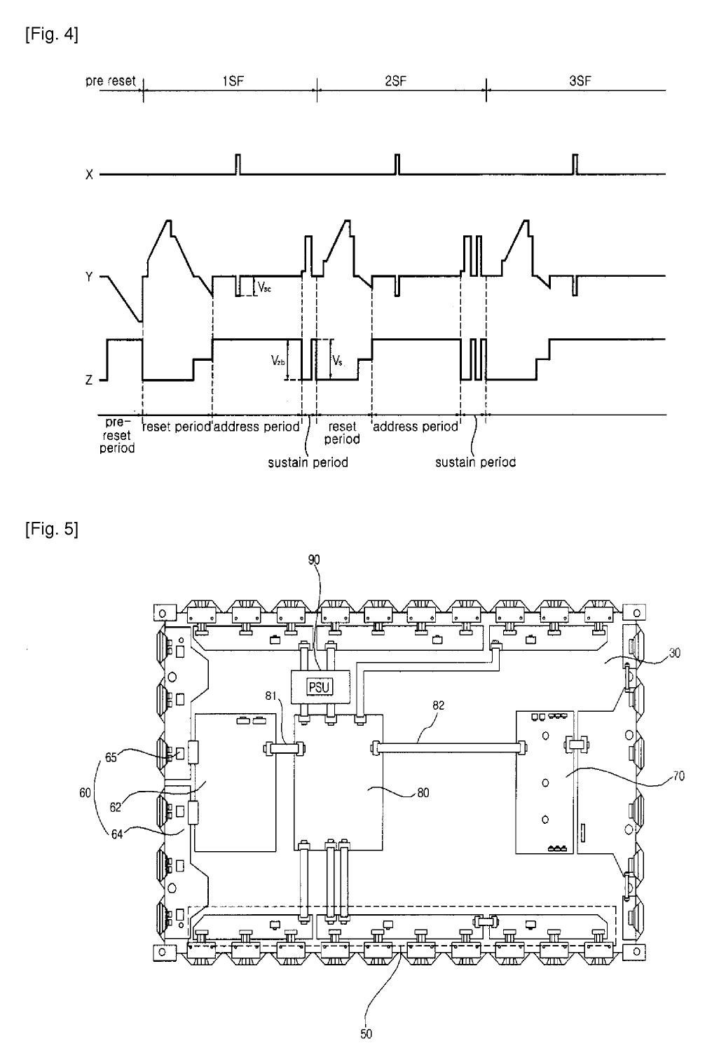

FIG. 4 is a timing diagram illustrating a driving signal for driving a plasma display panel in accordance with an embodiment of the present invention.

The subfield may comprise a preset period for forming positive wall charge on scan electrodes Y and negative wall charge, a reset period for initializing entire discharge cells using the wall charge distribution formed in the preset period, an address period for selecting discharge cells, and a sustain period for sustaining discharge of the selected discharge cells.

The reset period comprises a setup period and a setdown period. In the setup period, a rising ramp waveform (Ramp-up) is applied to all of the scan electrodes at the same time, thereby generating discharge in all of the discharge cells. Accordingly, a wall charge is formed therein. In the setdown period, a falling ramp waveform (Ramp-down) is applied to all of the scan electrodes Y at the same time, thereby generating erase discharge in all of the discharge cells. Accordingly, unnecessary charge is erased from the generated wall charges and the space charges. Here, the falling ramp waveform falls at a positive voltage that is lower than a peak voltage of the rising ramp waveform (Ramp-up).

In the address period, a scan signal having a negative scan voltage Vsc is sequentially applied to the scan electrode. At the same time, a positive data signal is applied to the address electrode X. A cell is selected by a voltage difference between the scan signal and the data signal and an address discharge that is generated by a wall voltage generated in the reset period. Meanwhile, a sustain vias voltage Vzb is applied to a sustain electrode during the address period in order to improve address discharge efficiency.

During the address period, a plurality of scan electrodes Y are divided into more than two groups, and scan signals may be sequentially applied to the scan electrodes Y by groups. The groups may be divided into more than two subgroups again, and the scan signals may be sequentially applied to the scan electrodes Y by the sub groups. For example, the plurality of scan electrodes Y are divided into the first and second groups, the scan signals are sequentially applied to the scan electrodes in the first group, and the scan signals are sequentially applied to the scan electrodes in the second group.

The plurality of scan electrodes Y according to an embodiment may be divided into a first group and a second group by a location of a scan electrode on a panel. For example, even numbers of scan electrodes Y are included in the first group, and odd numbers of scan electrodes Y are included in the second group. Furthermore, the plurality of scan electrodes Y according to another embodiment may be divided into a first group and a second group by the center of a panel. For example, scan electrodes Y in an upper portion of the panel are included in the first group, and scan electrodes Y in the lower portion of the panel are included in the second group.

In the sustain period, a sustain discharge is generated in a form of a surface discharge by alternatively applying a sustain pulse having a sustain voltage Vs to a scan electrode and a sustain electrode.

A width of the first or the last of the plurality of sustain signals, which are alternatively applied to the scan electrode and the sustain electrode in the sustain period, are greater than a width of the sustain pulse.

An erase period may be further comprised after the sustain period to erase a wall charge that remains in a scan electrode and a sustain electrode of an ON cell selected in the address period after generating the sustain discharge by generating weak discharge.

The erase period may be comprised in all of the subfields and some of the subfields. It is preferable to apply an erase signal for the weak discharge to an electrode where the last sustain pulse is not applied in the sustain period.

The erase signal may be a signal having a form of a gradually increasing ramp, a low voltage wide pulse, a high voltage narrow pulse, an exponentially increasing signal, or a half-sinusoidal pulse.

A plurality of pulses may be sequentially applied to a scan electrode or a sustain electrode in order to generate weak discharge.

The driving waveforms shown in FIG. 4 are only embodiments of signals for driving the plasma display panel. Therefore, the present invention is not limited thereto. For example, the pre-reset period may be omitted, and the polarities and voltage levels of the driving signals shown in FIG. 4 may be changed if it is necessary. The erase signal for erasing wall charge may be applied to a sustain electrode after completely finishing the sustain charge. Also, it is possible to perform single sustain driving in which sustain discharge is generated by applying the sustain signal to only one of the scan electrode Y and the sustain electrode Z.

FIG. 5 is a diagram illustrating a driving device for driving a plasma display panel in accordance with an embodiment of the present invention.

Referring to FIG. 5, a heat sink frame 30 is disposed at a rear side of a plasma display panel not only for supporting the plasma display panel but also for absorbing and discharging heat generated from the plasma display panel. Also, a printed circuit board is mounted at a rear side of the heat sink frame 30 for applying driving signals.

The printed circuit board comprises an address driver 50 for applying a driving signal to address electrodes of a plasma display panel, a scan driver 60 for applying a driving signal to scan electrodes of a plasma display panel, a sustain driver 70 for applying a driving signal to the sustain electrodes of a plasma display panel, a driver controller 80 for controlling the drivers, and a power supply unit (PSU) 90 for supplying power to each of the drivers.

The address driver 50 is disposed at a top side or a bottom side of the plasma display panel and applies a driving signal to the address electrodes on the plasma display panel to select discharge cells that discharge electricity among a plurality of discharge cells formed on the plasma display panel.

The address driver 50 may be disposed one or both of the top side and the bottom side of the plasma display panel according to a single scan method and a dual scan method.

The address driver 50 comprises a data IC (not shown) for controlling current applied to the address electrode and performs a switching operation for controlling current applied to the data IC. Accordingly, the address driver 50 may generate a large amount of heat. In order to overcome the heat problem of the address driver 50, the address driver 50 may comprise a heat sink (not shown).

As shown in FIG. 5, the scan driver 60 is disposed one of a right side and a left sift of the plasma display panel. The scan driver 60 may comprises a scan sustain board 62 connected to the driver controller 80 and a scan driver board 64 for connecting the scan sustain board 62 and the plasma display panel.

The scan driver board 64 may be divided into two parts and disposed at a top side and a bottom side of the plasma display panel. Unlike FIG. 5, the scan driver board 64 may be disposed as one or a plurality of parts.

The scan driver board 64 comprises a scan IC 65 for applying a driving signal to a scan electrode of the plasma display panel. The scan IC 65 can sequentially apply a reset signal, a scan signal, and a sustain signal to the scan electrode.

The sustain driver 70 may be disposed at one of a right side and a left side of a plasma display panel. Preferably, the sustain driver 70 is disposed at an opposite side of the scan driver 60. The sustain driver applies a driving signal to a sustain electrode of a plasma display panel.

The driver controller 80 processes input image signals using signal processing information stored in a memory, converts the input image signal to predetermined data to be applied to the address electrodes, and arranges the converted data according to a scan order. Also, the driver controller 80 controls a time of applying a driving signal to the drivers by applying a timing control signal to the address driver 50, the scan driver 60, and the sustain driver 70.

As shown in FIG. 5, the driver controller 80 and the scan driver 60, and the driver controller 80 and the sustain driver 70 may be connected through cables 81 and 82.

FIG. 6 is a diagram illustrating a display area and an non-display area of a plasma display panel. As shown, the plasma display panel may be divided into a display area 95 where images are displayed and a non-display area 97 where image are not displayed.

A driving signal is applied to discharge cells in the display area 95, and the discharge cells in the display area 95 are discharged according to an image to display. Therefore, the display area 95 displays the image. On the contrary, discharge cells in the non-display area 97 are not discharged in general. Although the discharge cells in the non-display area 97 are discharged, discharge from dummy cells located in the non-display area 97 is not related to an image to display. Therefore, the discharge of the dummy cells does not influence a displayed image.

Driving signals may be applied to electrode lines formed at the non-display area 79 and to electrodes formed at the display area 95. For example, if the scan driver 60 is disposed at the right side of the plasma display panel, the scan electrode line extends from the display area 95 to the right non-display area 97 of the plasma display panel and is connected to the scan driver 60.

If the sustain driver 70 is disposed at the left of the plasma display panel, the sustain electrode line extends from the display area 95 to the left non-display area 97 of the plasma display panel and is connected to the sustain driver 70.

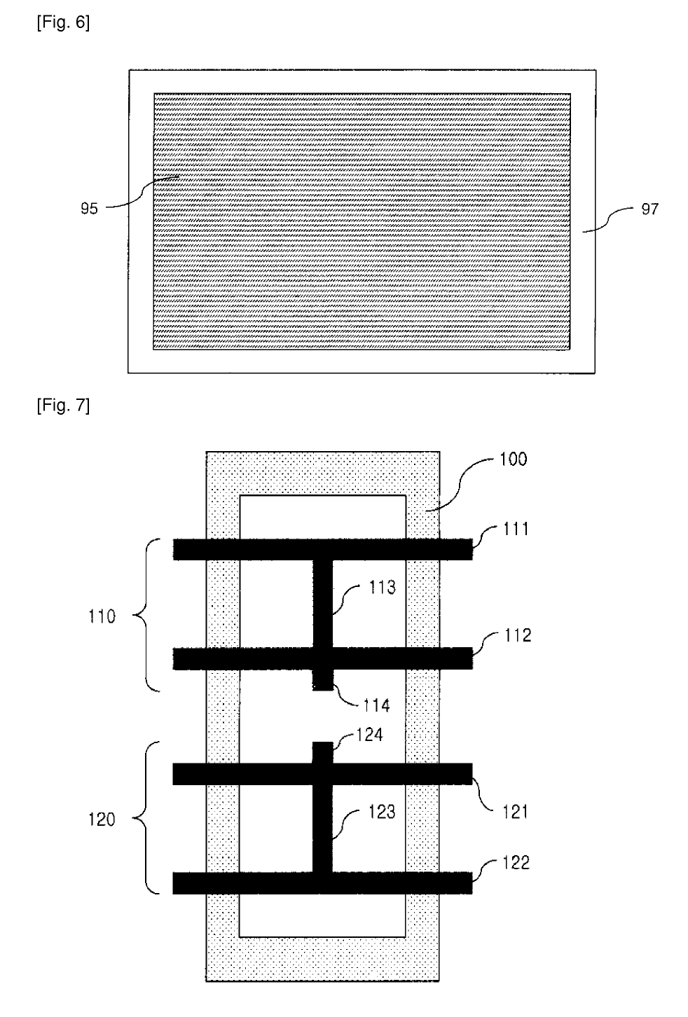

FIG. 7 to FIG. 9 are cross-sectional views of an electrode structure formed at an upper substrate of a plasma display panel in accordance with an embodiment of the present invention. That is, FIG. 7 to FIG. 9 illustrate an upper substrate electrode structure of a discharge cell disposed at the display area 95 of the panel.

Referring to FIG. 7, the sustain electrodes 110 and 120 according to an embodiment of the present invention form a pair to be symmetrical based on the discharge cell on the substrate. Each of the sustain electrodes 110 and 120 may be connected to at least two electrode lines 111, 112, 121, and 122 that cross discharge cells and to the closest electrode lines 112 and 121 from the center of the discharge cell. Each of the sustain electrodes 110 and 120 may comprise protrusion electrodes 114 and 124 that are protruded in a center direction of the discharge cell. Each of the sustain electrodes 110 and 120 may comprise more than two protrusion electrodes.

Each of the sustain electrodes 110 and 120 may further comprise connection electrodes 113 and 123 for connecting the two electrode lines 111 and 112, and 121 and 122.

The electrode lines 111, 112, 121, and 122 cross the discharge cells and extend in one direction of the plasma display panel. The electrode lines according to the present embodiment have a narrow width in order to improve an aperture rate. Although a plurality of electrode lines 111, 112, 121, and 122 are used to improve discharging diffusion efficiency, it is preferable to decide the number of the electrode lines in consideration of an aperture rate.

The protrusion electrodes 114 and 124 reduce a discharge firing voltage when the plasma display panel is driven. That is, it is possible to lower the discharge firing voltage of the plasma display panel because the adjacent protrusion electrodes 114 and 124 can start discharging with a low discharge firing voltage. Here, the discharge firing voltage is a voltage level that starts discharging when a pulse is applied to at least one of the sustain electrode pairs 110 and 120.

The connection electrodes 113 and 123 help discharging started from the protrusion electrodes 114 and 124 to be easily diffused to the electrode lines 111 and 133 that are far away from the center of the discharge cell.

The discharge firing voltage is lowered by the protrusion electrodes 114 and 124, and the discharging diffusion efficiency is improved using the plurality of electrode lines 111, 112, 121, and 122 as described above. Therefore, the overall emission efficiency of the plasma display panel can be improved. Accordingly, it is possible to remove ITO transparent electrodes without the luminance of the plasma display panel deteriorated.

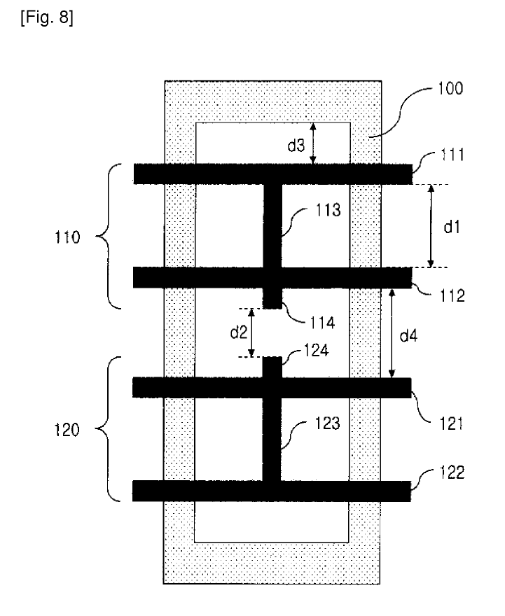

Referring to FIG. 8, the discharging diffusion efficiency may be reduced although the aperture rate of the plasma display panel increases as a gap d1 between two adjacent electrode lines 111 and 112 increases. If a gap d2 between two protrusion electrodes 114 and 124 increases, the discharge firing voltage may increase too.

Table 1 shows results of measuring discharge firing voltages that are changed according to variation of a gap d1 between adjacent two electrode lines 111 and 112 and a gap d2 between protrusion electrodes 114 and 124. Since a size of a discharge cell is limited, the gap d2 between the protrusion electrodes 114 and 124 may decrease as the gap d1 between two adjacent electrode lines 111 and 112 increases.

TABLE 1

| d1 | d2 | discharge firing voltage |
|---|---|---|
| 250 | 30 | 192 V |
| 240 | 40 | 188 V |
| 230 | 50 | 180 V |
| 220 | 60 | 179 V |
| 210 | 70 | 179 V |
| 200 | 80 | 181 V |
| 190 | 90 | 180 V |
| 180 | 100 | 179 V |
| 175 | 105 | 187 V |
| 170 | 110 | 188 V |
| 165 | 115 | 190 V |
| 160 | 120 | 191 V |

Referring to Table 1, the discharging diffusion efficiency is improved because the gap d1 between the two adjacent electrode lines 111 and 112 decreases according to the decrement of d1/d2. Therefore, the discharge firing voltage is lowered to below 180V when d1 is 4.5 times of d2.

However, the d2 between the protrusion electrodes 114 and 124 increases when d1/d2 exceeds 1.8 times. Accordingly, the discharge firing voltage abruptly increases higher than 187V.

When the gap d1 between the two adjacent electrode lines 111 and 112 is 1.8 times to 4.6 times of the gap d2 between the protrusion electrodes 114 and 124, it is possible to reduce the discharge firing voltage to about 180V.

Also, the gap d1 between the two adjacent electrode lines 111 and 112 may be about 2.1 times to 2.8 times of the gap d2 between the protrusion electrodes 114 and 124 in order to prevent deterioration of luminance of displayed image by securing an aperture rate of the plasma display panel and to uniformly generate discharging in entire area of the discharge cells.

Under an assumption that the length of the protrusion electrode 114 and 124 is between about 50 μm and about 100 μm, it is possible to stably reduce the discharge firing voltage to about 180V when the gap d1 between the two adjacent electrode lines 111 and 112 is about 0.6 times and 1.5 times of the gap d4 between two different sustain electrode lines 112 and 121.

If the gap d2 between the protrusion electrodes 114 and 124 is uniform, the gap d1 between the two electrode lines 111 and 112 is in reverse proportion to a gap d3 between the electrode line 111 and a barrier 100. If the gap d1 between the two adjacent electrode lines 111 and 112 increases, a discharging area of a discharge cell is widened or the discharging diffusion efficiency may be reduced.

If discharging is generated only at a part of the discharge cell, spots may be formed in a displayed image, thereby deteriorating an image quality.

Therefore, discharging may be uniformly generated in the entire area of the discharge cell when the gap d1 between the two adjacent electrode lines 111 and 112 is about one time or 1.7 times of the gap d3 between the electrode line 111 and the barrier 100. Accordingly, it is possible to reduce the image quality deterioration of the displayed image.

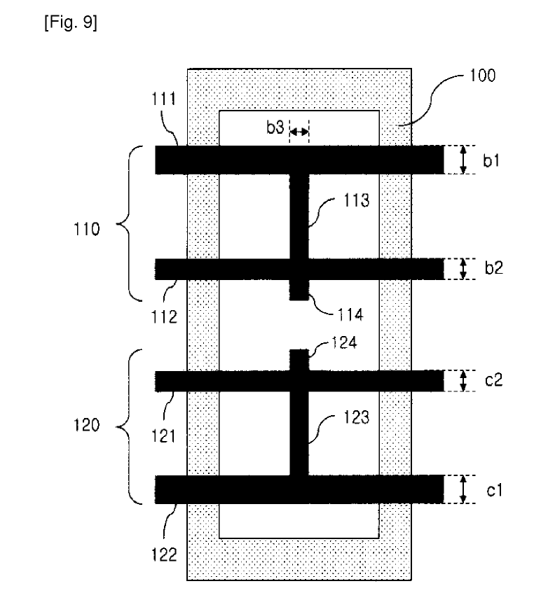

Referring to FIG. 9, the widths b1 and b2 of the two adjacent electrode lines 111 and 112 may be different from each other.

If amounts of wall charge formed at two electrode lines 111 and 112 by address discharging are different from each other, an amount of light generated by sustain discharging may be changed according to locations of the two electrode lines 111 and 112. Therefore, spots may be formed at a displayed image, and the image quality thereof is deteriorated.

For example, since the electrode line disposed at an outer ring of the discharge cell between the two electrode lines 111 and 112 form wall charge by diffused discharging, an amount of wall charge generated by address discharging may be smaller than the electrode line 112 adjacent to the center of the discharge cell. Therefore, it is possible to make amounts of wall charge formed at the two electrode lines 111 and 112 uniformly by forming a width b1 of the electrode line 111 disposed at the outer ring of the discharge cell greater than a width b2 of the electrode lines 112 adjacent to the center of the discharge cell.

By making the amount of wall charge formed at two electrode lines 111 and 112 uniformly, it is possible to uniformly generate discharging in the entire area of the discharge cell, thereby decreasing the deterioration of image quality of displayed image.

Table 2 shows results of whether spots are generated or not and measuring luminance of displayed image according to the variation of the widths b1 and b2 of the two adjacent electrode lines 111 and 112.

TABLE 2

| b1 μm | b2 μm | generation of spot | luminance (cd/m²) |
|---|---|---|---|
| 28 | 40 | ◯ | 485 |
| 32 | 40 | ◯ | 485 |
| 36 | 40 | ◯ | 484 |
| 40 | 40 | ◯ | 480 |
| 44 | 40 | X | 479 |
| 48 | 40 | X | 479 |
| 52 | 40 | X | 475 |
| 56 | 40 | X | 474 |
| 60 | 40 | X | 471 |
| 64 | 40 | X | 468 |
| 68 | 40 | X | 467 |
| 72 | 40 | X | 465 |
| 76 | 40 | X | 461 |
| 80 | 40 | X | 459 |
| 84 | 40 | X | 431 |
| 88 | 40 | X | 410 |
| 92 | 40 | X | 390 |
| 96 | 40 | X | 375 |

Referring to Table 2, when a width b1 of the electrode line 111 disposed at an outer ring of the discharge cell is thicker than 44 μm, the image quality is not deteriorated. For example, black spots are not generated. However, if the width b1 of the electrode line 111 disposed at the outer ring of the discharge cell is thicker than 80 μm, the luminance of the displayed image is abruptly decreased to below 460 cd/m².

Therefore, when the width d1 of the electrode line 111 disposed at the outer ring of the discharge cell is about 1.1 times or 2 times of the width b2 of the electrode line 112 adjacent to the center of the discharge cell, it is possible to prevent the image quality deterioration of the displayed image and improve the luminance thereof at the same time.

Also, the width b1 of the electrode line 111 disposed at the outer ring of the discharge cell may be 1.15 times or 1.5 times of the width b2 of the electrode line 112 adjacent to the center of the discharge cell in order to make an amount of wall charge formed at the two electrode lines 111 and 112 uniformly by increasing an amount of wall charge formed on the electrode line 111 without the discharging diffusion efficiency decreased.

Referring to Table 1 again, the gap d1 between the two adjacent electrode lines 111 and 112 may be about 180 μm to 230 μm, and referring to Table 2, the width b1 of the electrode line 111 is about 44 μm to 80 μm. Therefore, the gap d1 between the two adjacent electrode lines 111 and 112 is about 2.25 times to 5.2 times of the width b1 of the electrode line 111.

Therefore, widths c1 and c2 of two adjacent electrode lines 121 and 122 disposed at a lower side of the discharge cell can have different values in the above mentioned range.

A plasma display apparatus according to an embodiment of the present invention comprises a plasma display panel having a display area where an image is displayed and an non-display area disposed at the outer ring of the display area. The plasma display apparatus according to the present embodiment comprises a first electrode formed at the display area and the non-display area on the upper substrate, a second electrode forming a pair with the first electrode and formed on the display area, and a third electrode electrically insulated from the second electrode and formed in the non-display area.

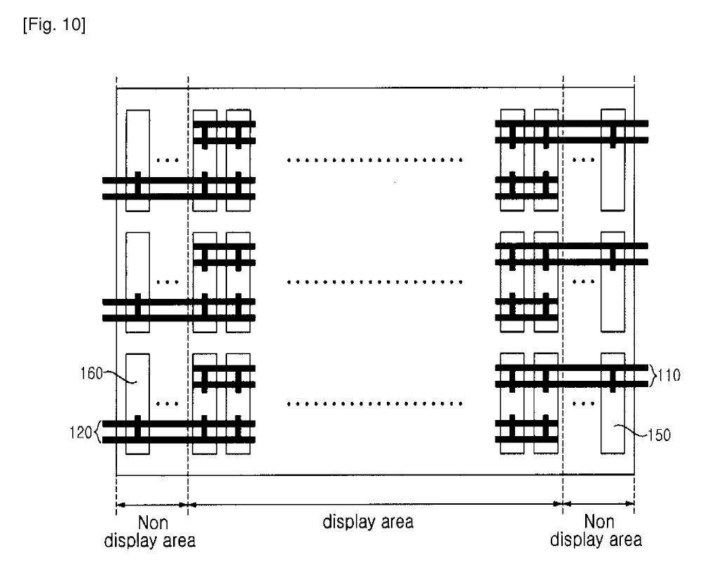

FIG. 10 is a cross-section view of an electrode structure formed on a display area and an non-display area of a plasma display panel. As shown, a scan driver 60 for applying a driving signal to the scan electrode 110 is disposed at a right side of the plasma display panel, and a sustain driver 70 for applying a driving signal to the sustain electrode 120 is disposed at the left side of the plasma display panel.

The first electrode may be a scan electrode.

Referring to FIG. 10, a line of the scan electrode 110 extends to the right side of the plasma display panel where the scan driver 60 is disposed and is formed on a dummy cell 160 in the non-display area at the right side of the plasma display panel. Therefore, a driving signal can be applied from the scan driver 60 to the scan electrode 110. On the contrary, the sustain electrode 120 may not be formed on the dummy cell 150 disposed in the non-display area at the right side of the panel.

Also, the line of the sustain electrode 120 extends to the left side of the panel where the sustain driver 70 is disposed, and is formed on the dummy cell 160 that is formed in the non-display area at the left side of the panel. Accordingly, a driving signal can be applied from the sustain driver 70 to the sustain electrode 120. On the contrary, the scan electrode 110 is not formed on the dummy cell 160 disposed in the non-display area at the left side of the panel.

In case of the electrode structure of the panel upper substrate as shown in FIG. 10, structures formed at the lower substrate such as barriers can be exposed to the outside through the dummy cells 150 and 160 of the non-display area, which is an area where the scan electrode 110 or the sustain electrode 120 is not formed. Accordingly, the non-display area reflects the external light entering to the plasma display panel, thereby dazzling eyes of a user. Or, the exterior appearance of the plasma display device may be spoiled.

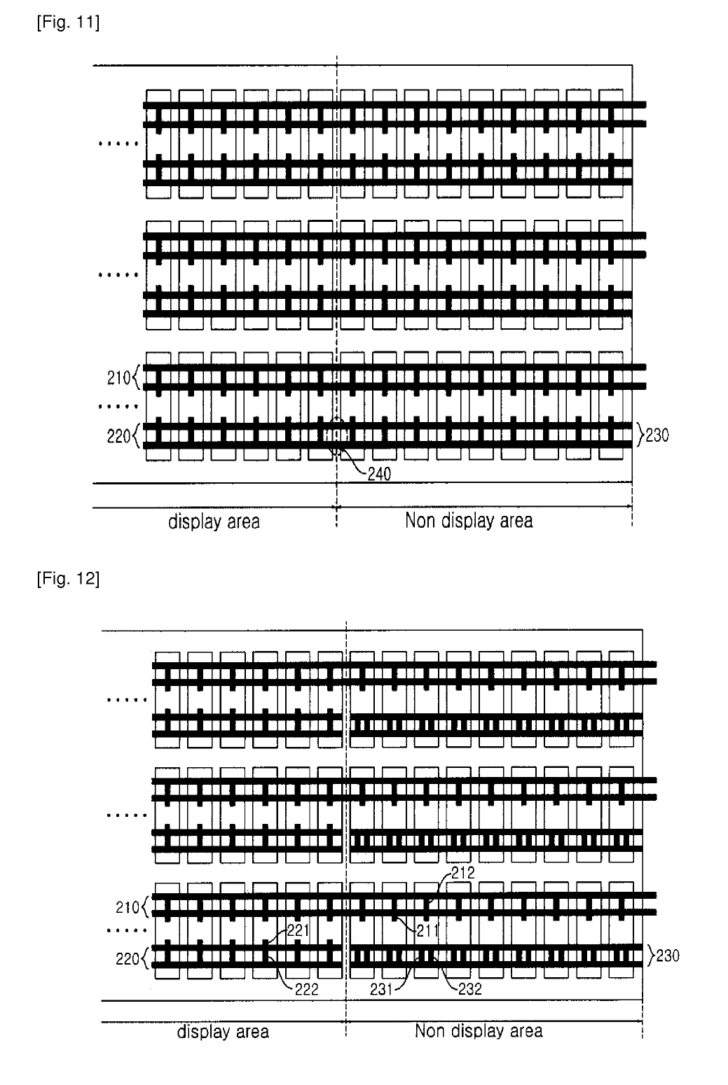

FIG. 11 to FIG. 19 are cross-sectional views illustrating electrode structures formed at an upper substrate of a plasma display panel in according to embodiments of the present invention. A scan driver 60 for applying a driving signal to a scan electrode is disposed at a right side of a plasma display panel.

Referring to FIG. 11, three dummy cells are formed in a line in a non-display area of the plasma display panel. The dummy cells may comprise R, G, B cells.

A line of the scan electrode 210 extends to the right side of the panel where the scan driver 60 is disposed and is formed on the dummy cells in the right non-display area of the panel. Although a shape of the scan electrode 210 formed in the display area is identical to the shape of the scan electrode 210 formed in the non-display area in FIG. 11, a shape of the scan electrode 210 in the display area may be different from that in the non-display area. For example, the number of connection electrodes in the scan electrode 210, the number of protrusion electrodes, the width of electrode line in the display area can be different from those in t the non-display area.

The line of the sustain electrode 220 is not formed on dummy cells in the non-display area at the right side of the panel.

The plasma display panel according to the present embodiment may comprise a separation electrode 230 that forms a pair with the scan electrode 210 or the sustain electrode 220 at the non-display area of the panel and formed on the upper substrate.

As shown in FIG. 11, the separation electrode 230 may be formed in the right non-display area of the panel where the sustain electrode 220 is not formed, or formed corresponding a location of the sustain electrode 220 in the display area.

The separation electrode 230 is separated from the sustain electrode 220 or the scan driver 60. That is, the separation electrode 230 is not electrically connected to the sustain electrode 220 or the scan driver 60. Therefore, a voltage is not applied from the outside. It is preferable that the separation electrode 230 and the sustain electrode 220 may be electrically insulated from the boundary 240 of the display area and the non-display area at a predetermined interval.

As shown in FIG. 11, it is possible to prevent lower substrate structures in the non-display area from being exposed to the outside by forming the separation electrode at the non-display area of the panel without additional process or influence to the panel driving. Therefore, it is possible to prevent the external light from reflecting.

A panel aperture rate of the non-display area may be lower than that of the display area. In general, the luminance of a displayed image decreases if the aperture rate of the panel becomes lowered. However, it is possible to further reduce exposure of the lower substrate structures by reducing the panel aperture rate because the non-display area is an area where an image is not displayed.

Meanwhile, a shape of the separation electrode 230 formed in the non-display area may be different from a shape of the scan electrode 210 formed on the dummy cells and shapes of the scan electrode 210 and the sustain electrode 220 formed in the display area.

Referring to FIG. 12, the separation electrode 230 in the non-display area may not comprise a protrusion electrode that is protruded in the center direction of the cell. That is, it is not easy to manufacture the protrusion electrode because of the shape thereof, and it is not necessary to reduce a discharge firing voltage at a dummy cell in the non display area because a voltage is not applied to the separation electrode 230. Therefore, the separation electrode 230 may not comprise the protrusion electrode in the present embodiment.

The separation electrode 230 formed in the non-display area may comprise the more number of connection electrodes 231 and 232 than those comprised in the scan electrode 210 or the sustain electrode 220. For example, the scan electrode 210 and the sustain electrode 220 comprise one connection electrode in one cell, and the separation electrode 230 may comprise at least two of connection electrodes 231 and 232 in one cell.

As described above, it is possible to a panel aperture rate of the non-display area may be reduced by increasing the number of connection electrodes 231 and 232 in the separation electrode 230.

A width of an electrode line forming the separation electrode 230 formed in the non-display area of the panel may be different from a width of an electrode line forming the scan electrode 210 or the sustain electrode 220.

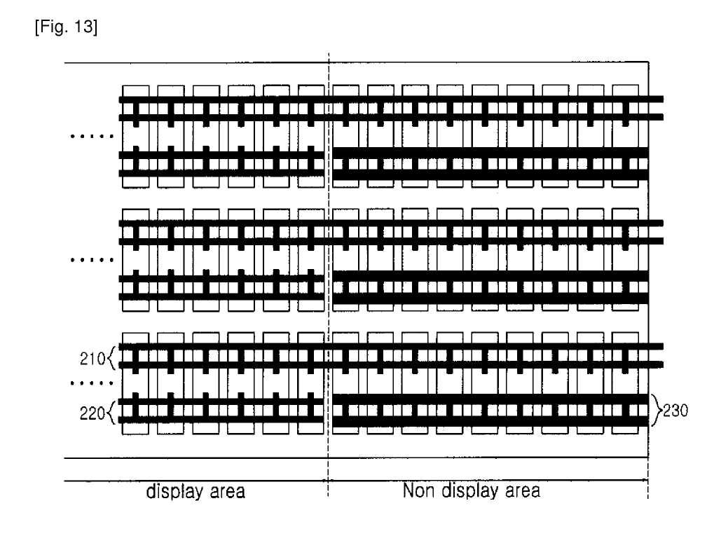

For example, as shown in FIG. 13, it is possible to reduce a panel aperture rate of the non-display area by making the width of the electrode line of the separation line 230 greater the width of the electrode line of the scan electrode 210 and the sustain electrode 220.

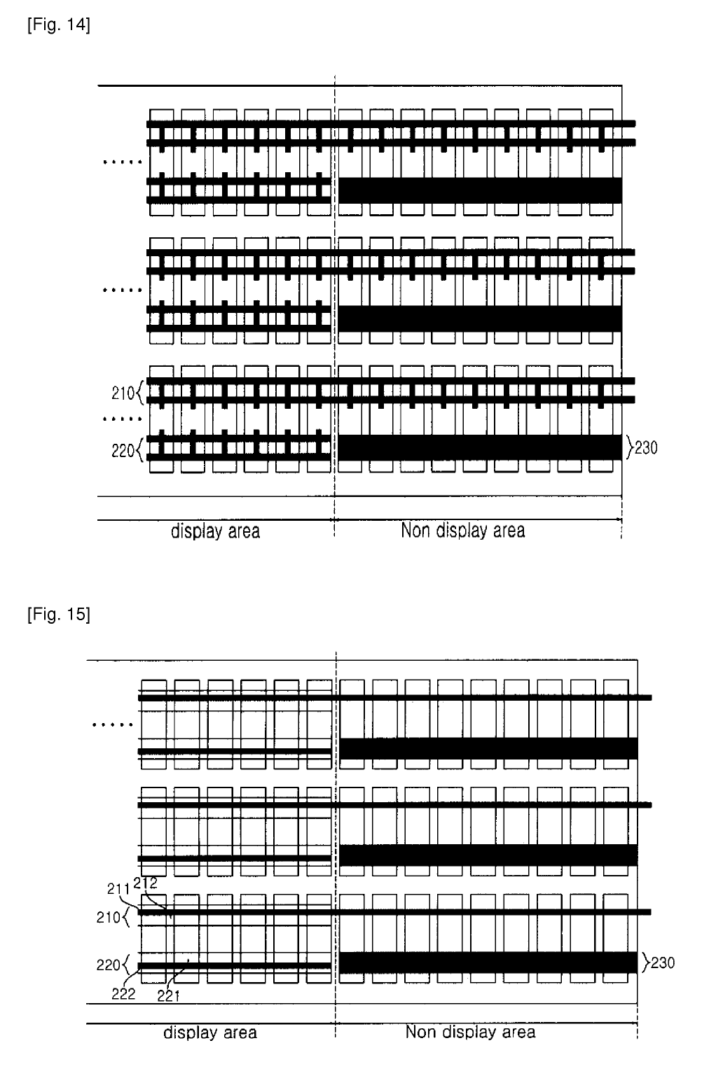

As shown in FIG. 14, the separation electrode 230 of the non-display area of the panel may be formed of one electrode line unlike the scan electrode 210 or the sustain electrode 220. In this case, a width of the separation electrode 230 may be greater than a width of an electrode line forming the scan electrode 210 or the sustain electrode 220.

Referring to FIG. 15, the scan electrode 210 and the sustain electrode 220 in the display area of the panel may have a stacking structure of metal bus electrodes 211 and 221 and transparent electrodes 212 and 222 made of ITO. The separation electrode 230 formed in the non-display area may have only a bus electrode without the transparent electrode made of ITO. In this case, it is preferable that a width of the bus electrode of the separation electrode 230 in the non-display area of the panel is wider than a width of the bus electrodes 211 and 221 of the scan electrode 210 and the sustain electrode 220 formed in the display area.

The scan electrode 210 in the non-display area may comprise only a bus electrode without a transparent electrode made of ITO.

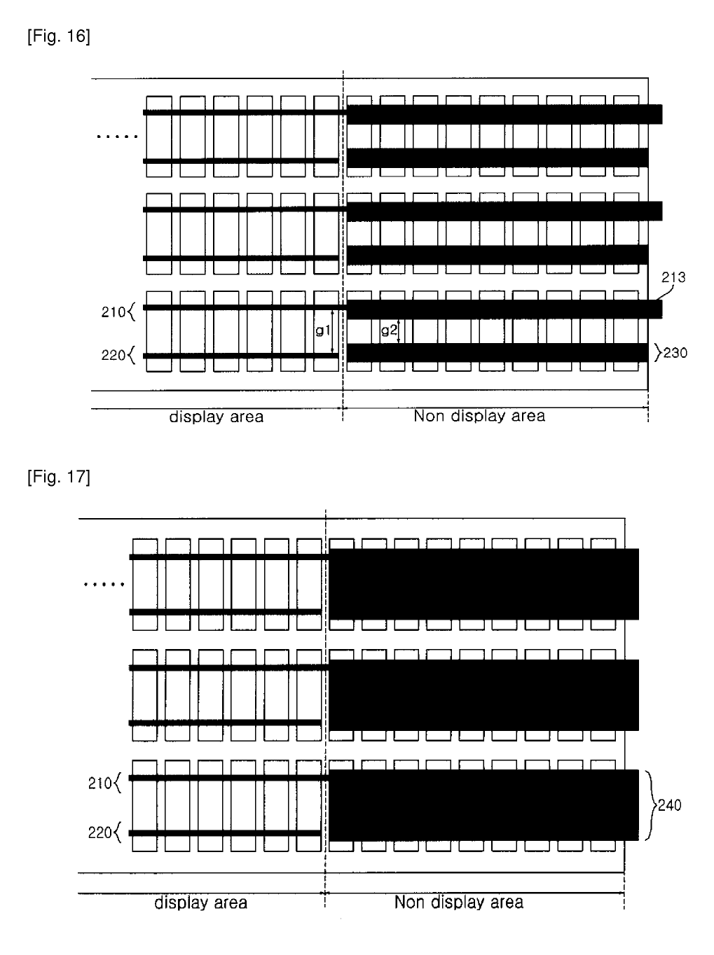

Referring to FIG. 16, a gap g2 between the scan electrode 230 and the separation electrode 230 may be narrower than a gap g1 between the scan electrode 210 and the sustain electrode 220 formed in the display area. For this, a width of the scan electrode 230 formed in the non-display area may be wider than a width of the scan electrode 210 formed in the display area.

In another embodiment of the present invention, a non-display area electrode 240 may be formed of integrally connected a scan electrode and a separation electrode, which are formed in the non-display area of a plasma display panel as shown in FIG. 17.

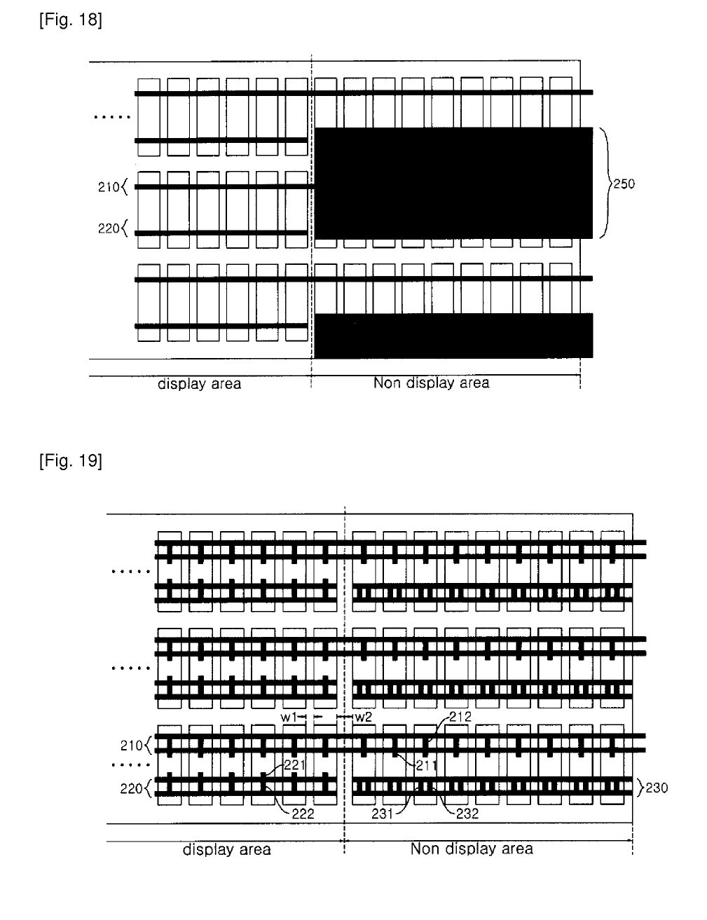

Also, a non-display area electrode 250 may be formed of integrally connected a scan electrode formed in a non-display area with more than two separations electrodes formed above or below the scan electrode as shown in FIG. 18.

A part connecting a scan electrode in a display area and an electrode in a non-display area may have a shape in which a width of an electrode gradually increases as shown in FIG. 16 to FIG. 18.

Referring to FIG. 19, a width w2 of a vertical bather formed between a display area and a non-display area may be greater than a width w1 of a vertical bather formed in the display area.

That is, it is possible to prevent discharging generated in the display area from influencing dummy cells in the non-display area by increasing the width w2 of the vertical barrier formed between the display and the non-display area. Therefore, error discharging in the dummy cells can be reduced.

Since discharging generated in one discharge cell can influence to adjacent discharge cells as a width w1 of a vertical barrier formed in the display area decreases, it is preferable that a width w2 of a vertical barrier formed between the display area and the non-display area is about 1.3 times to 1.65 times of a width w1 of a vertical bather formed in the display area in order to prevent error discharging in discharge cells in the display area and error discharging in the dummy cells.

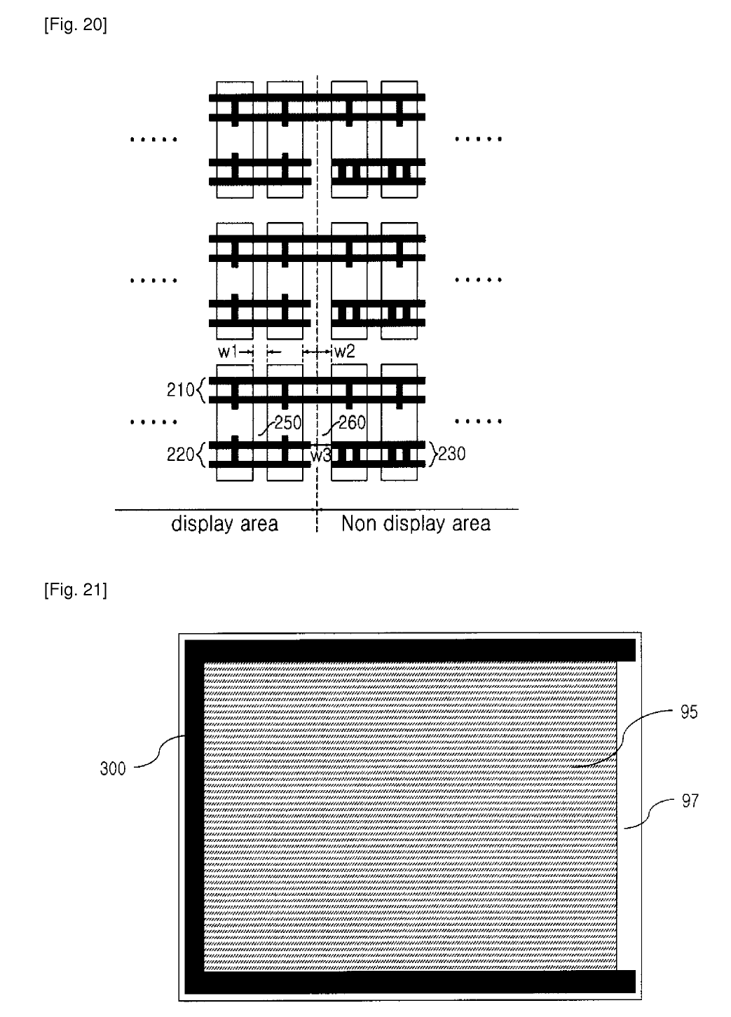

Referring to FIG. 20, the width w2 of the vertical barrier 260 formed between the display area and the non-display area may be greater than the width w1 of the vertical barrier 250 formed in the display area, a sustain electrode 220 formed in the display area extends and is formed on the vertical barrier 260 between the display area and the non-display area.

It is possible to prevent discharging between the scan electrode 210 and the sustain electrode 220 from instability at an end of the display area by extending the sustain electrode 220 in the display area to the vertical barrier 260 between the display area and the non-display area.

That is, it is preferable that a gap w3 between the sustain electrode 220 and the separation electrode 230 is smaller than a width w2 of the vertical bather 260 between the display area and the non-display area in order to stabilize discharging by preventing error discharging at the end of the display area.

Since the gap w3 between the sustain electrode 220 and the separation electrode 230 becomes narrower, discharging generated in the display area influences the dummy cells in the non-display area, thereby generating error discharging in the dummy cells.

Therefore, it is preferable that the gap w3 between the sustain electrode 220 and the separation electrode 230 is about 0.5 times of the width w2 of the vertical barrier 260 between the display area and the non-display area in order to prevent the error discharging on the dummy cells.

Unlike FIG. 20, the separation electrode 230 may extend to the vertical barrier 260 formed between the display area and the non-display area by manufacturing error.

FIG. 21 is a cross-sectional view illustrating a black matrix shape formed in a non-display area of a plasma display panel in accordance with a first embodiment of the present invention.

Referring to FIG. 21, a black matrix 300 may be formed in the non-display area of the plasma display panel. It is possible to prevent structures formed on a lower substrate from exposing to the outside by forming the black matrix 300 on the upper substrate of the non-display area 97 of the plasma display area.

It is also preferable that the black matrix is not formed on the non-display area at a right side of the plasma display panel where a scan driver 60 is disposed as shown in FIG. 21.

That is, it is difficult to form the scan electrode line and the black matrix in the non-display area at the right side of the panel because the scan electrode line extends in the non-display area at the right side of the panel.

In more detail, a bus electrode and a black matrix can be simultaneously formed on the upper substrate of the panel through exposure in order to reduce a time for a panel manufacturing process and make the panel manufacturing process easier. In this case, an electrode in the non-display area at the right side of the panel may be shorted.

Therefore, it is preferable not to form a black matrix at the right non-display area of the panel where the scan electrode lines extend as shown in FIG. 21.

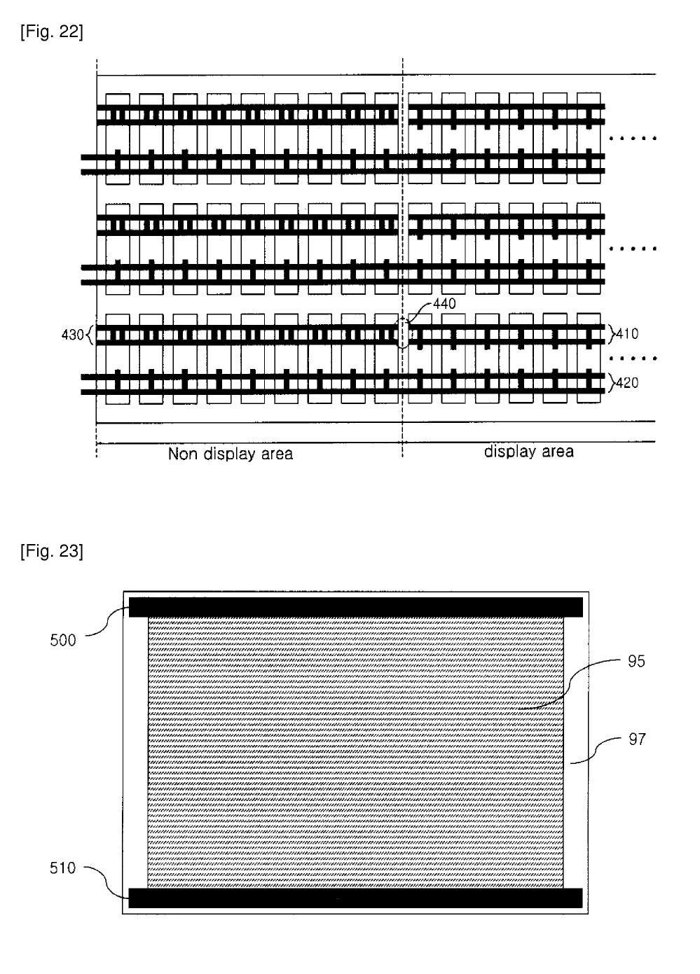

FIG. 22 is a cross-sectional view illustrating an electrode structure formed at an upper substrate of a plasma display panel in accordance with another embodiment of the present invention.

Referring to FIG. 22, a line of a sustain electrode 420 may extend to a left non-display area of the panel where a sustain driver 70 is disposed. Also, a line of the scan electrode 410 may be not formed on dummy cells disposed in the left non-display area of the panel.

A separation electrode 430, which forms a pair with the sustain electrode 420 on the upper substrate, may be formed in the entire left non-display area or a predetermined part thereof.

The separation electrode 430 is not electrically connected to the scan electrode 410 or the sustain driver 70 by being shorted. Therefore, a voltage may be not applied from an external device. Preferably, the separation electrode 430 and the scan electrode 410 may be shorted at a boundary part 440 of the display area and the non-display area.

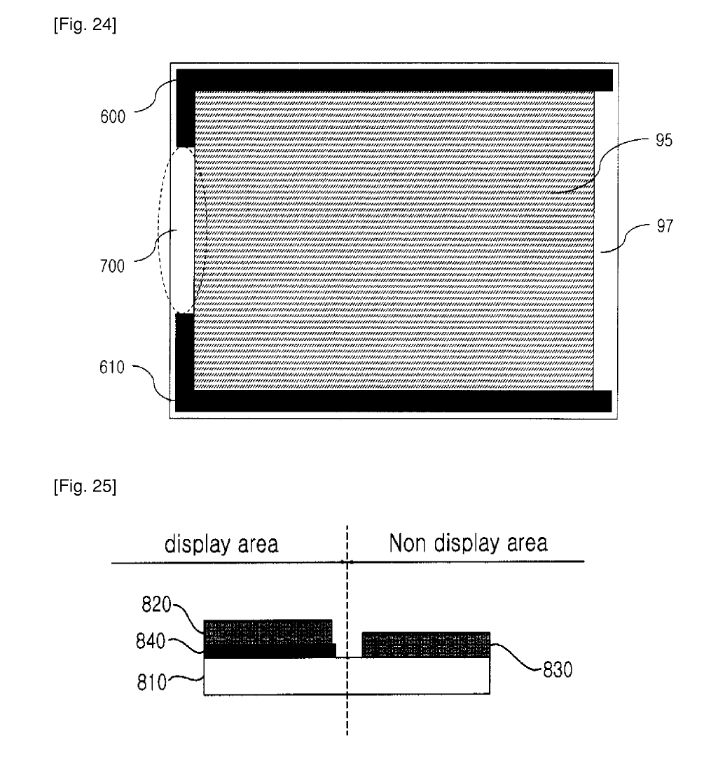

FIG. 23 and FIG. 24 are cross-sectional views illustrating a black matrix shape formed in an non-display area of a plasma display panel in accordance with second and third embodiments of the present invention.

As shown in FIG. 23, black matrixes 500 and 510 are formed at upper and lower non-display areas of the plasma display panel. A black matrix is not formed at left and right non-display areas where the sustain electrode line and the scan electrode line extend.

As shown in FIG. 24, a black matrix is not formed at a part 700 of a left non-display area of the plasma display area, and a separation electrode 430 is formed in the part 700 of the left non-display area as shown in FIG. 22.

In another embodiment, a black layer 840 is formed on the display area of the upper substrate 810, and a separation electrode 830 may be formed on the non-display area with separated from the black layer, as shown in FIG. 25.

A bus electrode 820 may be stacked on the black layer 840, and the bus electrode 820 may be a scan electrode or a sustain electrode.

The black layer 840 may be formed in a separation type where a part of the black layer 840 stacked with the scan electrode is separated from another part stacked with the sustain electrode. In this case, it is possible to simultaneously form the black layer 840 and the bus electrode 820 through exposure. Therefore, the black layer 840 may have the same shape of the bus electrode 820.

Also, the black layer 840 may be formed in an integral type in which a part of the black layer 840 stacked with the scan electrode is connected to another part stacked with the sustain electrode. The black layer 840 may be connected to a black matrix formed on a predetermined part of the upper substrate, which overlaps with a horizontal barrier of the lower substrate.

Since the black layer 840 can be electric conductive through exposure, the black layer 840 is formed to be electrically insulated from the scan electrode and the sustain electrode, thereby preventing electrodes from shorted in a right non-display are of the panel.

### INDUSTRIAL APPLICABILITY

As described above, the electrode is formed in the non-display area of the panel to be electrically insulated from the scan electrode or the sustain electrode in the plasma display apparatus according to the present embodiment. Therefore, it is possible to prevent structures of the lower substrate from exposing to the outside. Also, it is possible to reduce dazzling caused by an external light reflected from a frame area of displayed image. Furthermore, it is possible to make a manufacturing process simpler and to reduce a manufacturing cost by removing a transparent electrode from the plasma display panel.

The foregoing exemplary embodiments and aspects of the invention are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

1. A plasma display apparatus comprising a plasma display panel having a display area for displaying images and a non-display area disposed at an outer side of the display area, comprising:
a first electrode formed on the display area and the non-display area of an upper substrate;
a second electrode forming a pair with the first electrode and formed in the display area; and
a third electrode electrically insulated from the second electrode and formed in the non-display area.

2. The plasma display apparatus of claim 1, wherein the first electrode is a scan electrode.

3. The plasma display apparatus of claim 1, wherein each of the first, second, and third electrodes comprises first and second electrode lines formed in a direction crossing a fourth electrode formed on a lower substrate that is disposed to face the upper substrate; and at least one of connection electrodes for connecting the first and second electrode lines.

4. The plasma display apparatus of claim 3, wherein the number of the connection electrodes comprised in the third electrode is larger than the number of the connection electrodes comprised in one of the first and second electrodes.

5. The plasma display apparatus of claim 3, wherein each of the first and second electrodes comprises a protrusion electrode protruded in a center direction of a discharge cell from one of the first and second electrode lines.

6. The plasma display apparatus of claim 5 wherein the third electrode does not comprise the protrusion electrode.

7. The plasma display apparatus of claim 3, wherein at least one of widths of the first and second electrode lines comprised in the third electrode is wider than widths of the first and second electrode lines comprised in the first and second electrodes.

8. The plasma display apparatus of claim 1, wherein a voltage is not applied to the third electrode.

9. The plasma display apparatus of claim 1, wherein a black matrix is formed in a remaining non-display area except an non-display area disposed at one side of the plasma display panel.

10. The plasma display apparatus of claim 1, wherein each of the first and second electrodes comprises first and second electrode lines formed in a direction crossing a fourth electrode that is formed on a lower substrate disposed to face the upper substrate, and
the third electrode comprises an electrode line having a width wider than the first and second electrode lines.

11. The plasma display apparatus of claim 1 wherein each of the first and second electrodes comprises an ITO transparent electrode and a bus electrode, and
the third electrode comprises a bus electrode having a width wider than the first and second electrodes.

12. The plasma display apparatus of claim 1, wherein a gap between the first and third electrodes in the non-display area of the plasma display panel is narrower than a gap between the first and second electrodes in the display area of the plasma display panel.

13. The plasma display apparatus of claim 1, further comprising a second driver disposed at the other side of the panel for applying a driving signal to the second electrode,
wherein a fifth electrode is formed on the upper substrate to form a pair with the second electrode in a part of the non-display area disposed at the other side of the panel, and the first electrode is electrically insulated from the first electrode.

14. The plasma display apparatus of claim 1, wherein a width of a vertical barrier disposed between the display area and the non-display area is wider than a width of a vertical barrier disposed at the display area.

15. The plasma display apparatus of claim 14, wherein a width of a vertical barrier between the display area and the non-display area is about 1.3 times to 1.65 times of a width of a vertical barrier disposed in the display area.

16. The plasma display apparatus of claim 14, wherein a gap between the second electrode and the third electrode is smaller than a width of a vertical bather disposed between the display area and the non-display area.

17. The plasma display apparatus of claim 1, wherein the second electrode extends to at least a part on a vertical barrier disposed between the display area and the non-display area.

18. The plasma display apparatus of claim 17, wherein a gap between the second and fourth electrodes is about 0.5 times of a width of a vertical barrier disposed between the display area and the non-display area.

19. A plasma display apparatus comprising a plasma display panel having a display area for displaying images and an non-display area disposed at outer side of the display area, comprising:
a first electrode formed in the display area and the non-display area of an upper substrate;
a second electrode forming a pair with the first electrode and formed in the display area; and
a third electrode electrically insulated from the second electrode and formed integrally with the first electrode in the non-display area.

20. A plasma display apparatus comprising a plasma display panel having a display area for displaying images and an non-display area disposed at outer side of the display area, comprising:
a first electrode formed in the display area and the non-display area of an upper substrate;
a second electrode forming a pair with the first electrode and formed in the display area;
a black layer formed at the display area; and
a third electrode separated from the black layer and formed in the non-display area.
